(19) United States
(12) Patent Application Publication
(10) Pub. No.: US 2026/0276124 A1
(43) Pub. Date: Sep. 17, 2026

(54) Thermal Distributor

(71) Applicant: Bryan William Guderjohn, Glen Rock, PA (US)

(72) Inventor: Bryan William Guderjohn, Glen Rock, PA (US)

(21) Appl. No.: 19/079,925

(22) Filed: Mar. 14, 2025

(51) Int. Cl. F16L 41/03; A01M 13/00

(52) U.S. Cl. CPC F16L 41/03; A01M 13/00

(57) ABSTRACT

A thermal distributor includes a rectangular body having: a cylindrical intake channel extending away from the rectangular body. The thermal distributor further includes an intake air flow mechanism positioned to control intake of thermal energy within the intake channel. The thermal distributor further includes a plurality of outtake channels, each outtake channel includes a circumference smaller than a circumference of the intake channel.

### FIELD OF THE INVENTION

The present invention pertains to a thermal distributor, and, more particularly, to a thermal distributor system and process for terminating pests, which is designed for efficient and precise pest eradication by leveraging controlled thermal energy distribution.

### BACKGROUND

Insects invading homes, workplaces, and other locations continue to pose significant challenges for pest control. Among these pests, bed bugs are particularly difficult to eradicate due to their adept hiding behavior and growing resistance to common insecticides. Bed bugs often conceal themselves in cracks, crevices, and inaccessible areas, making it nearly impossible for chemical sprays to reach them effectively. While sprays can kill some bed bugs on contact, they rarely achieve complete extermination. Furthermore, many bed bugs have developed resistance to widely used insecticides, rendering these treatments less effective over time. As a result, homeowners and businesses frequently require professional pest control services that utilize specialized and often costly treatments to ensure successful eradication.

One of the most effective methods for exterminating bed bugs involves leveraging their thermal death point. Scientific studies indicate that adult and nymph bed bugs are killed at temperatures of 118° F., while their eggs require slightly higher temperatures of 122° F. for extermination. However, achieving these temperatures uniformly across an infested area requires sustained heat exposure over several hours. For instance, heating a room up to 200 square feet can take approximately 12 hours, while spaces between 200 and 400 square feet may require as long as 24 hours. The success of this method heavily depends on maintaining consistent and thorough heat distribution. Heated air must circulate effectively to penetrate cracks, crevices, and other concealed areas where bed bugs often reside.

Thermification is the process of producing thermal remediation (which is heated air and spinning that air with special high heat fans) and a high heat dehumidifier which will lower the relative humidity. Reducing the relative humidity in the air lowers the thermal death point of mold (from 147 degrees Thermal to 103 degrees thermal) and bed bugs (from 135 degrees Thermal to 94.5 degrees Thermal) by 30% allowing 100% death to all molds, bed bugs and eggs with just one treatment. This treatment can drastically reduce the amount of demolition for water damage when quickly addressed.

Despite the effectiveness of thermal treatments, there is currently no publicly available device or process capable of providing the level of control and precision necessary for efficient extermination. Existing solutions lack the ability to adjust thermal temperatures dynamically, regulate the amount of heat energy being distributed, and maintain consistent temperatures throughout the treatment space. This limitation significantly hinders the adoption of thermal methods by non-professional users, such as homeowners or small businesses, who seek accessible and reliable tools to address pest infestations. Therefore, there is a clear and urgent need for an advanced thermal distributor capable of overcoming these challenges by providing precise control, consistent performance, and effective heat circulation to achieve complete and efficient pest eradication.

### SUMMARY

A thermal distributor includes a rectangular body having: a cylindrical intake channel extending away from the rectangular body. The thermal distributor further includes an intake air flow mechanism positioned to control intake of thermal energy within the intake channel. The thermal distributor further includes a plurality of outtake channels, each outtake channel includes a circumference smaller than a circumference of the intake channel.

### BRIEF DESCRIPTION OF DRAWINGS

In the following, the present invention is described in more detail with references to the drawings in which:

FIG. 1 illustrates a front, top, and left side perspective view of a thermal distributor according to the invention;

FIG. 2 illustrates a rear, bottom, and right side perspective view of the thermal distributor;

FIG. 3 illustrates a detailed left side perspective view of the thermal distributor, emphasizing an intake channel, a cylindrical passageway, and an intake air flow mechanism according to the invention;

FIG. 4 illustrates a detailed right side perspective view of the thermal distribution;

FIG. 5 illustrates a cross-sectional view of the thermal distributor, showing internal components thereof;

FIG. 6 illustrates a process of an exemplary embodiment of the heat system; and

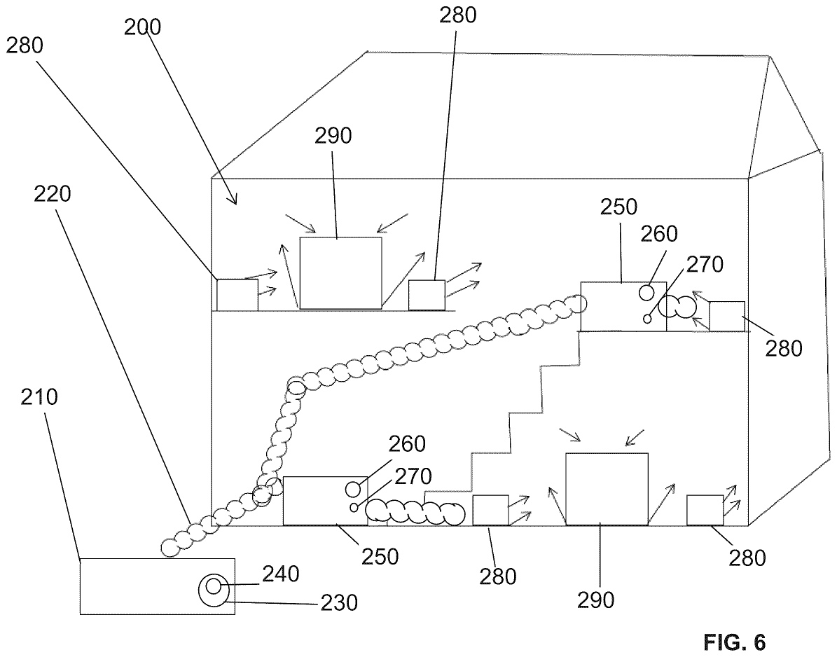

FIG. 7 illustrates a process map of an exemplary embodiment of the heat system.

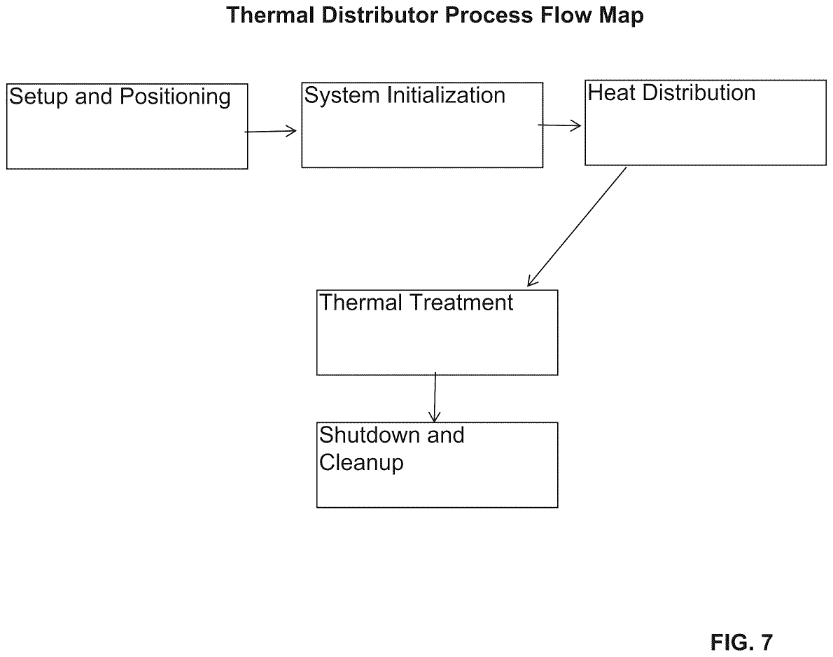

### DETAILED DESCRIPTION OF THE EMBODIMENTS

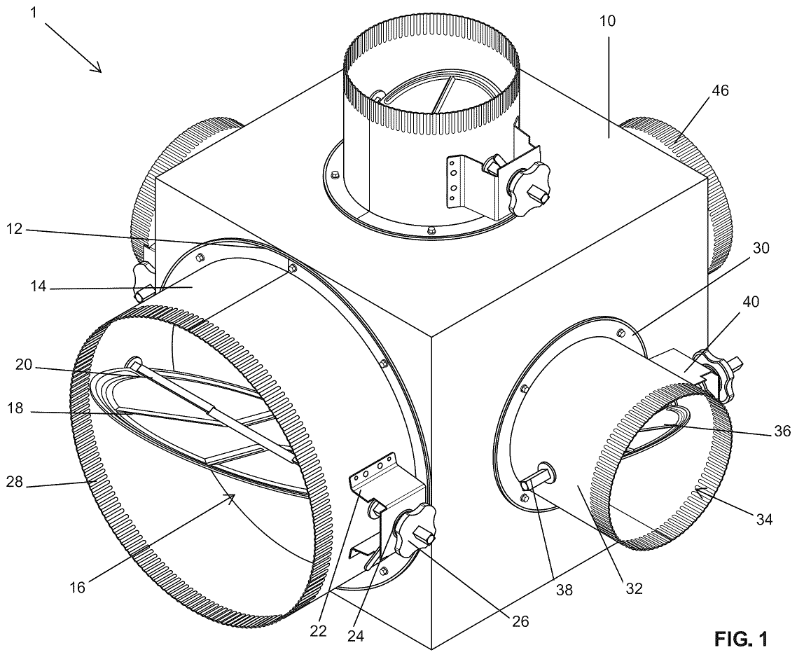

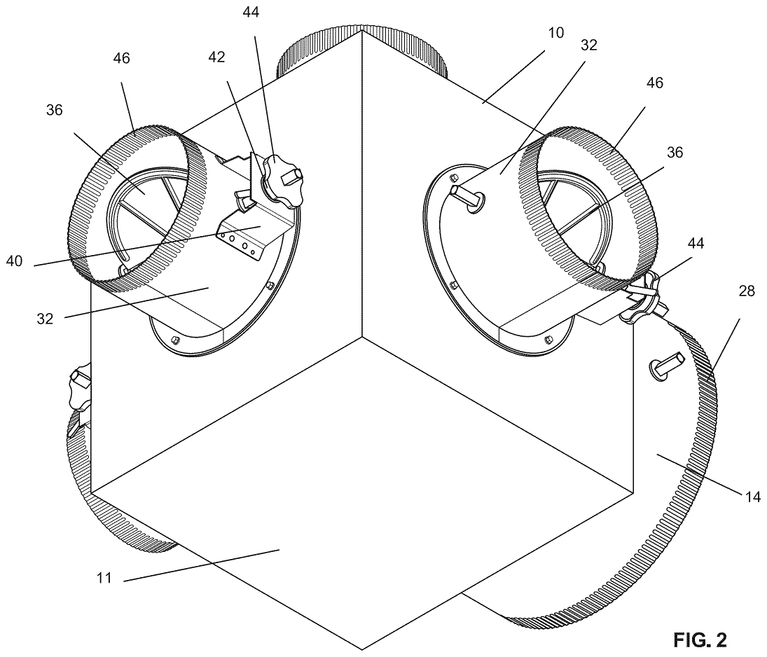

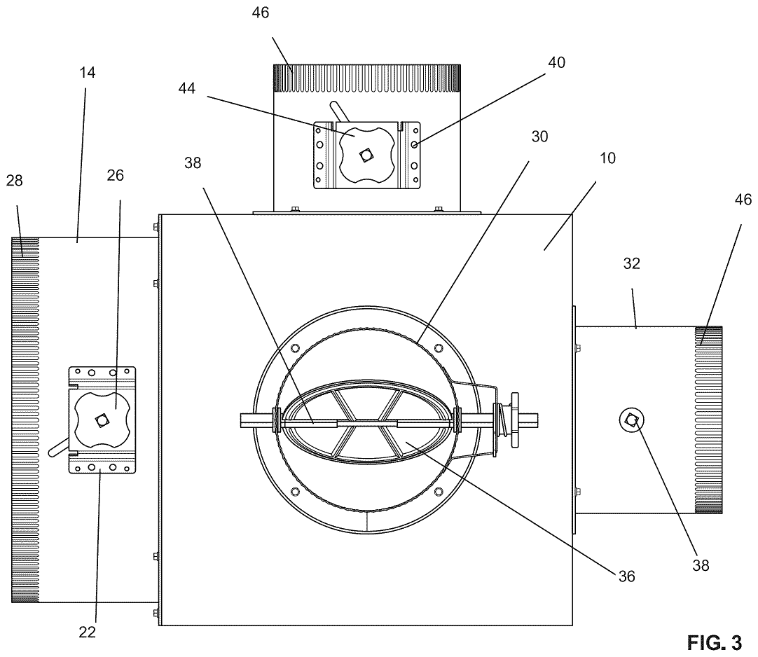

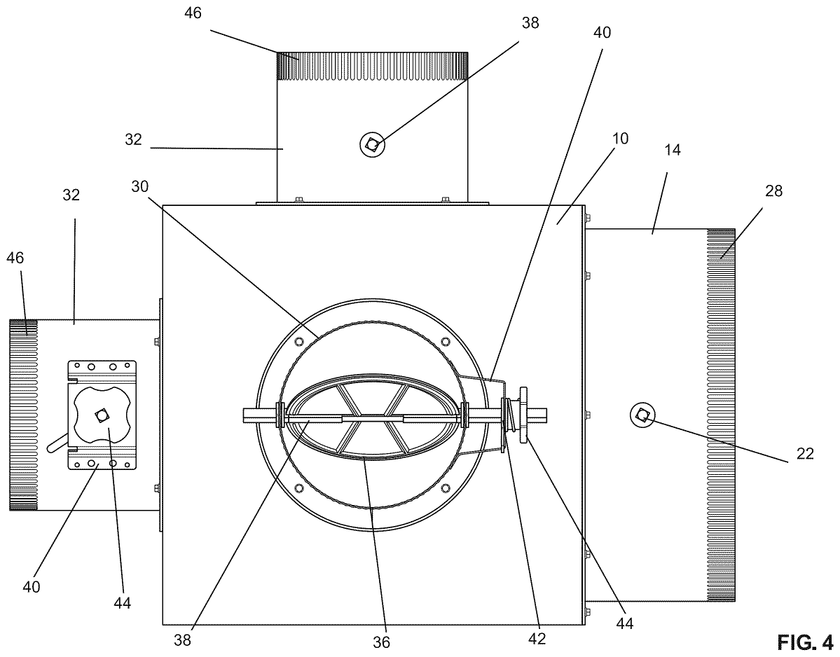

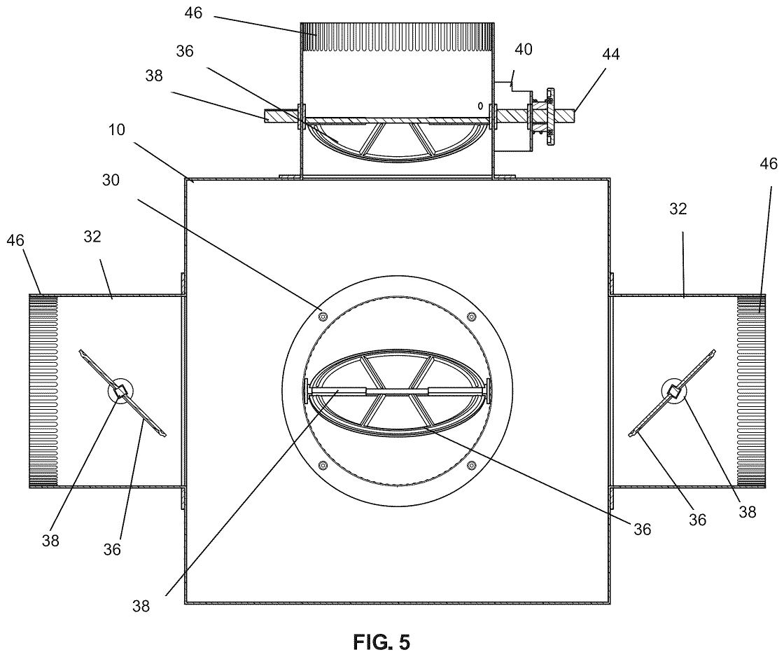

In the exemplary embodiment and represented by FIGS. 1-5, an exemplary device and process of efficiency eliminating bed bugs or other pests is presented.

In the exemplary embodiment, a heat distribution device 1 generally includes a rectangular body 10. The rectangular body 10 may have dimensions of 16×16, but dimensions may be altered to fit the need of the user. One skilled in the art would understand the applicant's design is not the exclusive embodiment.

In the exemplary embodiment, the rectangular body 10 includes an intake channel 12. The intake channel 12 is a cylindrical passageway providing access to an inner portion of the rectangular body 10. The intake channel 12 further includes a wall 14 extending away from the rectangular body 10 and positioned on a perimeter of the intake channel 12, defining its structural boundary. The intake channel 12 incorporates an intake air flow mechanism 16, which plays a crucial role in managing and directing the air entering the system.

In the exemplary embodiment, the intake air flow mechanism 16 includes an air curtain 18. The air curtain 18 is a circular member that facilitates the controlled inflow of air, ensuring consistent and efficient operation.

The air curtain 18 is a circular member with a circumference similar to the inner portion of the wall 14, ensuring a secure and functional fit. This component, constructed from durable, heat-resistant materials, ensures the integrity of airflow regulation under high-temperature conditions. One skilled in the art would understand that the applicant's design is not the exclusive embodiment. Alternative configurations could include segmented air curtains for modular adjustment or perforated designs for fine-tuned airflow diffusion.

In the exemplary embodiment, the intake air flow mechanism 16 further includes a rotational device 20. The rotational device 20 is an elongated member extending across the width of the air flow mechanism 16, allowing for precise movement of the air curtain 18.

Additionally, the intake air flow mechanism 16 includes a stabilization member 22. The stabilization member 22 is a U-shaped component coupled to a portion of the wall 14 to provide structural support and reduce vibrations during operation. The stabilization member 22 also includes a passageway 24 extending through its central portion, which facilitates uninterrupted airflow while maintaining the alignment of the rotational device 20.

The intake air flow mechanism 16 further includes a control mechanism 26. The control mechanism 26 serves as the user interface for adjusting airflow parameters.

In the exemplary embodiment, the control mechanism 26 is coupled to the air curtain 18 via the stabilization member 22. This design allows for coordinated operation of the air curtain 18 and stabilization member 22, ensuring smooth and precise airflow control.

The control mechanism 26 is depicted as a rotatable knob that permits the rotational device 20 to rotate the air curtain 18 three-hundred and sixty degrees in both clockwise and counterclockwise directions. This functionality provides users with comprehensive control over the direction and intensity of air entering the intake channel 12, allowing for customization based on the specific treatment requirements.

The intake channel 12 further includes a plurality of grooves 28 positioned around its opening, where the wall 14 ends. These grooves are designed to facilitate the secure attachment of industry-standard hosing. In the exemplary embodiment, the grooves are evenly spaced for compatibility with common hosing configurations, but alternative designs could feature adjustable or modular grooves to accommodate various connector types.

The rectangular body 10 also includes a plurality of outtake channels 30, which are positioned symmetrically on each side of the rectangular body 10, excluding the base 11. This arrangement ensures even and effective heat distribution throughout the treatment area.

Each outtake channel 30 is a cylindrical passageway providing access to the inner portion of the rectangular body 10. Each outtake channel 30 has a smaller circumference than the intake channel 12, a design that increases the velocity of the exiting air. The outtake channel 30 further includes a wall 32 extending away from the rectangular body 10, forming its structural perimeter and supporting its components.

The outtake air flow mechanism 34 is integrated within each outtake channel 30. Similar to the intake air flow mechanism 16, the outtake air flow mechanism 34 includes an air curtain 36, which regulates the outflow of heated air.

In the exemplary embodiment, the air curtain 36 is a circular member with a circumference similar to the inner portion of the wall 32. This ensures consistent and controlled airflow exiting the rectangular body 10. One skilled in the art would understand that alternative designs could include adjustable louvers or multi-layered curtains for specific applications.

The outtake air flow mechanism 34 further includes a rotational device 38. This device spans the width of the air flow mechanism, enabling precise directional adjustments of the air curtain 36.

To support the outtake air flow mechanism, a stabilization member 40 is included. This U-shaped component couples to a portion of the wall 32 and includes a passageway 42 through its central portion, allowing unimpeded airflow and secure alignment of the rotational device 38.

The outtake air flow mechanism 34 is controlled by a control mechanism 44, which is coupled to the air curtain 36 via the stabilization member 40.

The control mechanism 44, similar to its intake counterpart, is a rotatable knob that permits the rotational device 38 to rotate the air curtain 36 three-hundred and sixty degrees in both clockwise and counterclockwise directions. This feature allows users to customize the direction and intensity of heat exiting the outtake channels 30.

The outtake channels 30 also include a plurality of grooves 46 around their openings, enabling secure attachment of industry-standard hosing. These grooves, as depicted in the exemplary embodiment, are fixed, but interchangeable or modular configurations could be used to enhance versatility.

The user can alter the flow of thermal energy within the rectangular body 10 by adjusting the control mechanisms 26 and 44 on both the intake channel 12 and the outtake channels 30. This allows for precise customization of the temperature and velocity of the heated air exiting the system, targeting pests such as bed bugs and molds effectively.

The thermal distributor system, referred to as the heat system 200, provides a modular and adaptable solution for controlled heat application in pest control and related applications. It includes innovative components such as the indirect heater 210, collapsible tubing 220, the heat distribution device 1 referred to as the adjustable air control mechanism 250, air flow distributors 280, dehumidifiers 290 and other integrated systems for monitoring and efficiency.

In the exemplary embodiment, the process begins with positioning of the indirect heater 210 and coupling tubing 220 to the outports of the indirect heater 210.

In the exemplary embodiment, the process continues by positioning the air control mechanism 250 in a central or accessible location near the treatment area to optimize heat distribution. The collapsible tubing 220 is securely attached to the intake and outtake ports of the air control mechanism 250 using built-in connectors designed for easy assembly and an airtight seal. The tubing 220 is then extended into specific treatment zones, such as cracks, corners, or concealed spaces where pests like bed bugs or mold typically reside.

Adjustable supports or brackets ensure that the tubing 220 remains properly positioned for effective heat delivery.

In the exemplary embodiment, the process continues by positioning at least one air flow distributor 280 in the desired space permitting the air flow distributor 280 to carry the hot air released from the air control mechanism 250 and rotate the heated air creating thermal convection.

In the exemplary embodiment, the process continues by positioning at least one dehumidifier 290 within the space. The high temperature dehumidifier 290 reduces the moisture in the heat air which in turn lowers the thermal death point of the desired pest or mold.

Once the heat system 200 is in place, the indirect heater 210 is activated to begin the preheating process. Using the adjustable air control mechanism 230 positioned on the indirect heater 210, the user sets the desired temperature and airflow based on the requirements of the treatment area. The system preheats efficiently, ensuring consistent thermal energy inflow. Integrated monitoring sensors 240 within the indirect heater 210 verify that the indirect heater 210 has reached the required operational temperature before heat distribution begins, ensuring smooth and effective operation.

When the system is operational, heated air flows through the collapsible tubing 220 into the adjustable air control mechanism 250. The adjustable air control mechanism 250, coupled to the collapsible tubing 220, is capable of 360-degree adjustments, allows precise control over the direction and intensity of the heat. This ensures thorough coverage of the treatment area while maintaining flexibility for dynamic adjustments. For larger or more complex spaces, the user can reposition the tubing 220 or couple additional tubing 220 to the outtake ports of the air control mechanism 250 or redirect airflow using the control interface 260 positioned on the adjustable air control mechanism 250, further enhancing the system's adaptability.

During the thermal treatment phase, the system maintains the target temperature, such as a temperature between 120° F.-135° F. Specifically, 118° F. for eradicating adult and nymph bed bugs or 122° F. for eliminating eggs. In mold situations, the current death point of mold is 147° F., however, in the thermal treatment phase this process reduces the molds death point to 103° F.

In the exemplary embodiment, the real-time temperature monitoring system 270 is positioned on an outer portion of the adjustable air control mechanism 250 ensuring consistent heat application throughout the treatment duration. Heat is applied for the necessary time based on the size and complexity of the treatment area, with tubing 220 adjustments as needed to ensure even heat distribution.

After completing the treatment, the components of the heat system 200 are powered down, and the collapsible tubing 220 is detached, collapsed, and stored for future use. All components, are inspected and cleaned to ensure optimal performance and longevity. This process provides an efficient, precise, and safe solution for targeted thermal applications in pest control and beyond.

It should be noted that various changes and modifications to the embodiments described herein will be apparent to those skilled in the art. Such changes and modifications may include alternative body shapes (e.g., cylindrical or hexagonal designs), enhanced material choices, or automated adjustment systems. These variations may be implemented without departing from the spirit and scope of the present invention.

What is claimed is:

1. A thermal distributor, comprises:
a rectangular body having:
a cylindrical intake channel extending away from the rectangular body;
an intake air flow mechanism positioned to control intake of thermal energy within the cylindrical intake channel; and
a plurality of outtake channels, each outtake channel includes a circumference smaller than a circumference of the cylindrical intake channel.

2. The thermal distributor of claim 1, wherein the intake air flow mechanism further includes an air curtain, positioned within an inner portion of the cylindrical intake channel.

3. The thermal distributor of claim 2, wherein the intake air flow mechanism further includes a control mechanism coupled to the air curtain providing rotation of the air curtain.

4. The thermal distributor of claim 3, wherein air curtain rotates three-hundred and sixty degrees in both a clockwise direction and a counter clockwise direction.

5. The thermal distributor of claim 1, wherein each outtake channel of the plurality of outtake channels further includes an outtake air flow mechanism.

6. The thermal distributor of claim 5, wherein the intake air flow mechanism further includes an air curtain positioned within each inner portion of the outtake channel.

7. The thermal distributor of claim 1, wherein the intake air flow mechanism further includes a stabilization member positioned on an outer wall of the cylindrical intake channel.

8. The thermal distributor of claim 7, wherein the stabilization member further includes a passageway extending through a central portion.

9. The thermal distributor of claim 8, wherein the intake air flow mechanism further includes a control mechanism.

10. The thermal distributor of claim 9, wherein intake air flow mechanism further includes an air curtain within the cylindrical intake channel.

11. The thermal distributor of claim 10, wherein the intake air flow mechanism further includes a stabilization member extending across a width of the air curtain.

12. The thermal distributor of claim 11, wherein the control mechanism is coupled to the air curtain by the stabilization member.

13. A process of a heat system comprising:
activating an indirect heater;
coupling a first end of a tubing to the indirect heater;
positioning an air control mechanism within an interior structure and coupling a second end of the tubing to the air control mechanism;
positioning at least one air flow distributor within the interior structure; and
providing at least one dehumidifier within the interior structure.

14. The process of the heat system of claim 13, wherein air from the indirect heater flows through the tubing and into the air control mechanism through an intake port of the air control mechanism.

15. The process of the heat system of claim 14, wherein the heated air flows through the tubing coupled to at least one outtake port of the air control mechanism.

16. The process of the heat system of claim 15, wherein the heat air is carried by the air flow distributor and rotated creating thermal convection.

17. The process of the heat system of claim 16, wherein the dehumidifier reduces moisture of the heated air lowering a thermal death point of a pest.
